(19) United States
(12) Patent Application Publication
(10) Pub. No.: US 2002/0119352 A1
(43) Pub. Date: Aug. 29, 2002

(54) Fuel cell installation and associated operating method

(76) Inventors: Manfred Baldauf, Erlangen (DE); Rolf Bruck, Bergisch Gladbach (DE); Ulrich Gebhardt, Langensendelbach (DE); Joachim Grosse, Erlangen (DE); Jorg-Roman Konieczny, Siegburg (DE); Gunter Luft, Lauf (DE); Kurt Pantel, Heroldsberg (DE); Walter Preidel, Erlangen (DE); Meike Reizig, Erpel (DE); Manfred Waidhas, Nurnberg (DE)

Correspondence Address: LERNER AND GREENBERG, P.A., Post Office Box 2480, Hollywood, FL, 33022-2480, US

(21) Appl. No.: 10/105,553

(22) Filed: Mar. 25, 2002

Related U.S. Application Data
(63) Continuation of application No. PCT/DE00/03238, filed on Sep. 18, 2000.

(30) Foreign Application Priority Data
Sep. 23, 1999 (DE) 199 45 715.8

(51) Int. Cl. H01M 8/04; H01M 8/06

(52) U.S. Cl. 429/13; 429/26; 429/22; 429/17; 429/24; 429/21

(57) ABSTRACT

The fuel cell installation is operated at temperatures between 80° C. and 300° C. and ensures that the efficiency is optimized, since the waste heat from the fuel cell stack is utilized at least in some other way. For the purpose, there is provided an evaporator upstream of the fuel cell stack. At least one line is connected to the fuel cell stack for rendering available a heat content from at least a part of the fuel cell stack to be utilized in one or more further units of the installation.

### CROSS-REFERENCE TO RELATED APPLICATION

This application is a continuation of copending International Application No. PCT/DE00/03238, filed Sep. 18, 2000, which designated the United States.

### BACKGROUND OF THE INVENTION

### Field of the Invention

The invention lies in the fuel cell technology field and pertains, more specifically, to a fuel cell installation and to an operating method for a fuel cell installation of this type. The invention is advantageously employed in a direct methanol fuel cell (DMFC).

DMFC fuel cells and PEM fuel cells are currently being tested for use in motor vehicles. The system of a direct methanol fuel cell (DMFC) differs from the hydrogen polymer electrolyte membrane (PEM=Proton Exchange Membrane or Polymer Electrolyte Membrane) fuel cell substantially through the fact that the fuel methanol is converted at the anode directly, i.e. without an intervening reformer. For this purpose, the fuel introduced into the fuel cell is either pure methanol or a methanol/water mixture, which reacts at the anode according to the following equation:

CH₃OH+H₂O-->CO₂+6H⁺+6e⁻.

German patent application DE 196 25 621 A1 discloses a direct methanol fuel cell installation which is operated with gaseous fuel. For this purpose, an evaporator is connected upstream of the cell and/or the stack. Moreover, the installation provides a condenser which is connected downstream of the stack and wherein the carbon dioxide which is formed is separated out of the anode off-gas before the latter is returned to the evaporator. A drawback of the facility is that the energy for the evaporator has to be supplied externally.

### SUMMARY OF THE INVENTION

It is accordingly an object of the invention to provide a fuel cell installation and an associated operating method, which overcomes the above-mentioned disadvantages of the heretofore-known devices and methods of this general type and which further improves the efficiency of such fuel cell facilities.

With the foregoing and other objects in view there is provided, in accordance with the invention, a fuel cell installation, comprising:

at least one fuel cell stack, process-medium supply lines connected to the fuel cell stack, and electrical lines;

an evaporator connected upstream of the fuel cell stack in a flow direction; and

at least one line connected to the fuel cell stack for rendering a heat content from at least a part of the fuel cell stack available to be utilized in at least one further unit.

There is further provided, in accordance with the invention, a starter cartridge for starting the fuel cell installation, the starter cartridge containing a methanol/water mixture suitable for conversion at the anode in ready-to-use form.

With the above and other objects in view there is also provided, in accordance with the invention and in combination with a fuel cell installation, a hydrogen store connected in the fuel cell installation.

With the above and other objects in view there is also provided a method of operating a fuel cell installation, which comprises utilizing waste heat from at least one part of a fuel cell stack in an operation of the fuel cell installation.

Finally, there is provided a method of operating a direct methanol fuel cell installation, which comprises providing an evaporator and operating the evaporator at an operating temperature below a temperature of a fuel-cell stack off-gas.

In other words, the invention provides a fuel cell installation having at least one fuel cell stack, process-medium supply lines, electrical lines and upstream evaporator, wherein there is at least one line which allows the heat from at least one part of the stack to be utilized in at least one further unit. In the method according to the invention for operation of a fuel cell installation, the waste heat from at least one part of the fuel cell stack is utilized in a different way.

The invention may be implemented in particular on a direct methanol fuel cell. In this case, the fuel is an alcohol, preferably methanol, which is reacted directly in the fuel cell.

In the invention, the term line encompasses not only a pipe, a flexible tube or any other physical connection between two elements of the facility, but also any other connection, i.e. including thermal contact. The term “unit” which is being heated is understood to mean primarily an element of the fuel cell installation, such as the evaporator, the condenser, the preheating for the fuel, the unit for preheating the process medium, the gas-cleaning facility and/or the compressor. However, the term also encompasses the heating of a unit or space which lies outside the facility and/or any further utilization of the first waste heat, as well as the utilization of the second waste heat from the fuel cell stack, namely the waste heat from one of the abovementioned units. The utilization of the second waste heat includes, for example, the utilization of the waste heat from the evaporator for heating a living space or passenger compartment, depending on whether the fuel cell installation is employed in a mobile or stationary application. The abovementioned elements or units are all heat exchangers and cool the hot gases and/or liquids which are introduced.

The utilization of the waste heat from a fuel cell stack, which is also known to the specialists simply as a stack for short, is possible on the one hand by using at least one off-gas and/or a heated cooling medium which, for example, is passed from the stack into the evaporator and, on the other hand, by means of thermal contact wherein, for example, the evaporator is integrated in the stack.

According to one embodiment, the evaporator is arranged in a housing together with the stack and/or is integrated into the end plates of the stack.

Integration of the evaporator in the stack also means, for example, that the process medium which is to be heated is guided between the fuel cell units in order to cool them.

According to one embodiment of the method, the fuel cell stack is operated at temperatures of over 80° C. and below 300° C., preferably between 100° C. and 220° C., and in particular at a temperature of approx. 160° C. In accordance with the high operating temperature, according to the invention a DMFC facility can also be referred to as a high-temperature polymer electrolyte membrane fuel cell (HTM fuel cell).

It is preferable for the facility to be operated in such a way that recyclable constituents of the anode off-gas and/or cathode off-gas, such as water and/or methanol, are recovered and/or recirculated.

For example, according to one embodiment, the facility comprises a condenser, through which the anode off-gas is passed. In the process, the mixture of methanol and water contained in the anode off-gas is condensed and separated from the carbon dioxide. The condensed fuels are either introduced directly into the evaporator and/or mixer to form the water/methanol mixture or are introduced into a tank.

According to one embodiment, the cathode off-gas, which contains product water, is cooled by being introduced into a heat exchanger, such as an evaporator and/or condenser, so that the product water condenses out and can be separated from the waste air. The water which forms is either fed to the fuel in order to form the methanol/water mixture required or is fed into the water tank.

According to one embodiment, the methanol and/or water separated out is fed to a tank contained in the facility. In this case, it is advantageous for an analysis unit, such as a sensor, to be contained in the tank and/or a feed line, which analysis unit firstly indicates the quantity of liquid in the tank and its temperature and secondly indicates the composition and/or purity of the liquid and/or of the gas mixture which is formed above the liquid. A corresponding analysis unit may also be provided in other containers, lines and/or units of the facility.

To protect against freezing, the water tank may also contain a methanol/water mixture which ensures that the methanol/water mixture in the tank is present in liquid form at temperatures which lie below the freezing point of water. For this purpose, a specific water/methanol mixing ratio is established manually or automatically by means of a control unit. A sensor for determining the methanol content in the mixture, a corresponding metering device and a methanol tank are advantageous for this purpose. By way of example, a mixture containing 30% by weight of methanol in water ensures a freezing point of approximately −25° C.

The gas cleaning is effected, for example, by means of an adsorber and/or a catalyst, which can be used in combination with the condenser or on its own in order to separate out the methanol, the water, an inert gas, such as the carbon dioxide, and/or an undesired by-product, such as carbon monoxide, aldehyde, carboxylic acid, etc. The gas mixture is passed through the adsorber/catalyst, which consists, for example, of soda-lime, zeolites and/or a membrane.

According to a preferred embodiment, the gas cleaning is controlled with the aid of sensors, wherein case, by way of example, at each gas outlet there is arranged a sensor which measures the temperature, composition and/or quantity of gas released into the environment and transmits these values to a control unit.

The gas cleaning may, for example, also be combined with the condenser and/or a unit for preheating the process medium, to form a catalytically coated heat exchanger into which the methanol-containing off-gas is introduced. In this variant, electrical heating is advantageous for the cold start, in order to ensure that the working temperature of the catalytic coating is reached quickly. Moreover, the waste heat from the gas cleaning can be utilized, for example, via a further heat exchanger.

According to a preferred embodiment, the cooling capacity of the evaporator is utilized to condense the off-gas, so that the evaporator and the condenser form a module or a heat exchanger.

During the cold start, to achieve an improved start-up performance, it is advantageous to protect against freezing of the stack and/or to reach the operating temperature in at least part of a stack of the facility. For this purpose, under certain circumstances it is preferable to insulate at least part of a stack rather than maintaining the operating temperature by part-load operation. This insulation is produced, for example, by a double-walled housing, which under certain circumstances may be filled with phase change materials. If part of the stack is insulated, the remaining part is heated, for example, by the waste heat from this part. For the insulation, low-temperature insulation, primarily against convection and/or heat conduction, preferably an air gap or vacuum insulation, is preferred. It is advantageous to utilize phase change materials. It is advantageous for it to be possible to close at least one feed opening of a process-medium and/or coolant feed line when the stack is being shut down, for example by means of electrically actuable flaps and/or thermostatic valves.

In the same way as for the housing of the stack, to prevent freezing, for example of the water required in the DMFC, insulation of further modules, units, lines and/or tanks of the DMFC facility may be advantageous. The term module encompasses not only a stack but also a mixer, a pump, a gas-cleaning facility, etc. In this case too, an air gap or vacuum insulation is possible, preferably in combination with phase change materials. It is also possible, in combination with temperature sensors, to use active heating during the at-rest phase of the facility, wherein case the energy supply required is made available by means of an additional energy store (high-power battery) or by partial operation of the stack.

According to a preferred embodiment, the water tank can be dispensed with altogether if, to start the facility, there is a starter cartridge, wherein the methanol/water mixture which is suitable for reaction at the anode is present in ready-to-use form. The starter cartridge may form a permanent reservoir which is constantly refilled during operation, or may be a disposable container. The volume of the starter cartridge is selected according to the size of the fuel cell stack. The composition of the methanol/water mixture in the cartridge is at least 1:1, preferably with excess water. After the facility has been started, the product water is then circulated in such a way that it supplies the quantity of water for the water/methanol mixture which is required for reaction at the anode. Refueling with pure methanol achieves the highest possible energy content per volumetric part if the facility is used, for example, for mobile applications.

According to one configuration of the method, during the cold start the facility is started up using liquid fuel, wherein case the minimum stack temperature for starting is predetermined by the freezing point of the electrolyte.

According to one embodiment, to start up the DMFC facility, hydrogen is passed into the stack, since with hydrogen the stack can be started at much lower temperatures than if the methanol/water mixture is used.

In this embodiment, a suitable hydrogen store, such as a palladium sponge, a pressure vessel and/or a hydride store is also fitted.

According to one embodiment, the hydrogen store, for example while the facility is operating, is electrolytically refilled from the water and/or water/methanol tank. The electrolysis is carried out using an additional electrolysis unit, or a stack or part of a stack is utilized for electrolysis.

In this embodiment, the energy required for the electrolysis can be made available by a partial stack of the facility directly and/or by an energy store, such as a battery or a capacitor.

The hydrogen which remains unused after the facility has been started can be utilized to heat a unit such as the evaporator or can simply be introduced into the gas-cleaning facility.

To produce a stronger temperature gradient, the cooling medium can be guided in co-current during the cold start. In this context, the term in co-current means that the cooling medium is guided in co-current with the process medium or media. Following the cold start, a temperature profile which is as uniform as possible is produced in the stack by switching over to countercurrent operation.

According to one embodiment, to avoid contaminants in the cell or damage caused by foreign bodies entering the process-medium and/or coolant feed line (e.g. the air supply) and/or in some other way, a filter is provided upstream of the cell. The type of filter is preferably adapted to the type of line, so that a fine filter is connected upstream of the process-medium feed line, on account of the narrow distribution ducts in the reaction chambers, and a coarse filter is connected upstream of the coolant feed line. The filtration of the process medium can also be carried out, with the pressure loss being minimized, by a combination of an upstream coarse filter and a downstream electrostatic filter.

Air can be used both as the oxidizing agent and as the cooling medium.

According to one embodiment, the installation includes a control unit, which receives information and current measured values, such as for example the result from an analysis unit, the operating temperature and/or temperature distribution in the stack, the profile of the instantaneous current/voltage curve, the operating pressure, the volumetric flow rates and/or the methanol concentration which prevails at various locations. The control unit then compares the actual values which are received with predetermined and/or calculated set values and uses control devices, such as a metering valve, a pump, a separator, a compressor, a heater, a cooler, a blower, a pressure-regulating valve, etc., to automatically and/or manually control the facility in such a way that the actual values are made to correspond to the set values. The control unit is generally used to optimize the efficiency and/or to optimally adapt to the power required from the facility (for example via the pressure applied to the accelerator pedal). In particular, the control unit allows the power to be controlled as a function of stack voltage (allows the facility to be operated with optimum utilization of the load), allows water management, which, for example together with a starter cartridge, eliminates the need to carry a water tank, and allows optimum energy utilization of the facility.

The installation is controlled and designed in such a way that heating and cooling of the individual components, such as evaporator, preheater, compressor and/or preheating module, on the one hand, which all require heat, and stack, condenser, optional cooling system and/or water separator, on the other hand, which are all cooled, are combined with optimum utilization of the energy.

With the above and other objects in view there is also provided, in accordance with the invention, a fuel cell installation, comprising:

at least one fuel cell stack of DMFC fuel cells operated with a methanol/water mixture at an operating temperature between 100° C. and 300° C.;

process-medium supply lines of an operating circuit connected to the fuel cell stack;

an evaporator connected upstream of the fuel cell stack in a flow direction for evaporating the methanol/water mixture; and

a condenser connected to the fuel cell stack for condensing at least water out of the anode off gas and/or the cathode off gas; and

a feedback for recycling condensate water into the operating circuit.

With the above and other objects in view there is furthermore provided, in accordance with the invention, a method of operating a fuel cell installation having a fuel cell stack of DMFC fuel cells operated with evaporated methanol/water mixture and having an evaporator connected upstream thereof, the method which comprises:

operating the fuel cell stack in an operating temperature range between 100° C. and 300° C. with evaporated methanol/water mixture;

introducing fuel cell off gases at the high operating temperature of the fuel cell stack into a condenser for recovering water and/or methanol; and

recovering useful components of the off gases and/or recycling the useful components of the off gases into the operating circuit.

Other features which are considered as characteristic for the invention are set forth in the appended claims.

Although the invention is illustrated and described herein as embodied in a fuel cell installation and associated operating method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of two specific exemplary embodiments when read in connection with the accompanying drawings.

### BRIEF DESCRIPTION OF THE DRAWINGS

FIG. 1 is a block circuit diagram of a first embodiment of a direct methanol fuel cell installation according to the invention; and

FIG. 2 is a block circuit diagram of a second embodiment of a direct methanol fuel cell installation according to the invention.

### DESCRIPTION OF THE PREFERRED EMBODIMENTS

The reference symbols used in the two circuit diagrams are identical for structurally and functionally equivalent components. Lines are named in such a way that the reference numeral used for the upstream element is placed in front of the reference numeral for the downstream element (e.g. line 1311 is the line wherein the fluid flows from element 13 to element 11):

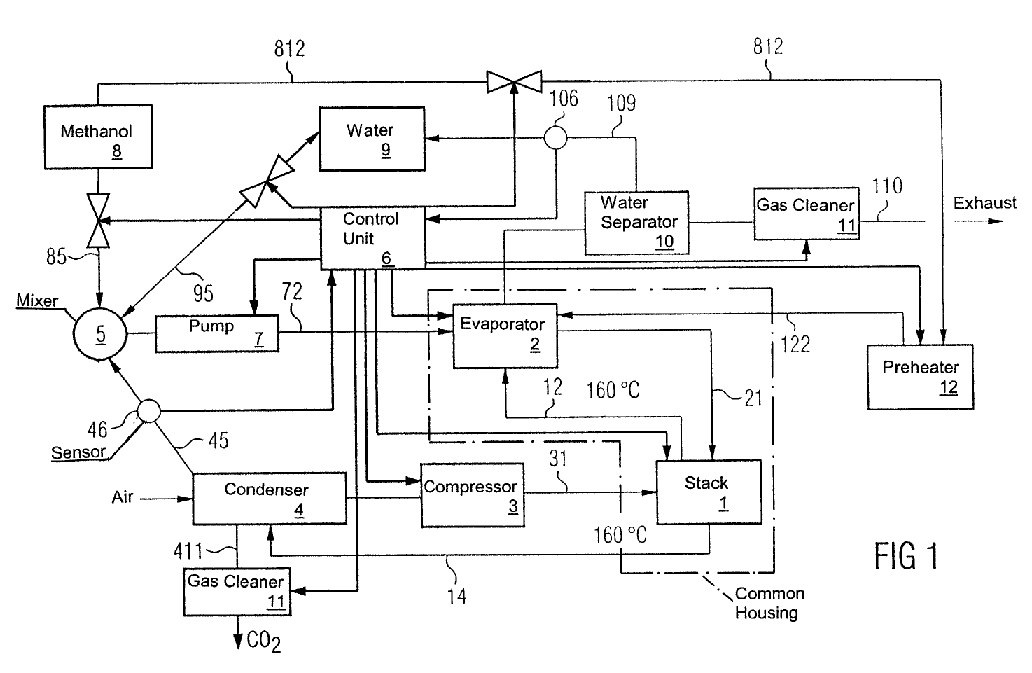

Referring now to the figures of the drawing in detail and first, particularly, to FIG. 1 thereof, there is shown a stack 1 which is connected to the evaporator 2 firstly via the process-medium feed line 21 and secondly via the process-medium discharge line 12. For the sake of clarity, the figure only shows one stack 1 of the direct methanol fuel cell installation, although a facility with a plurality of stacks is under certain circumstances advantageous, inter alia with low-voltage modules for on-board power supply.

A process-medium feed line 31 leads from the compressor 3 to the stack 1. A heat exchanger or condenser 4 is connected upstream of the compressor 3, which is controlled in a load-dependent manner via the control unit 6, and this heat exchanger or condenser 4 for its part is connected to the stack 1 via the process-medium discharge line 14 in such a way that the waste heat from the anode chamber of the stack 1 is utilized to preheat the oxidizing agent air, since the consumed fuel is introduced into the heat exchanger 4 through the line 14 at a temperature of approx. 160° C. In the heat exchanger 4, water and/or unused methanol is separated from the carbon dioxide and other gaseous impurities by condensation. The liquid phase which is obtained in the heat exchanger 4 is fed into the mixer 5 via the line 45. Direct feed into the methanol tank 8 (via a non-illustrated line 48) is also possible. In that case, a sensor in the line 48 is advantageous for analyzing the composition. The line 45 has a sensor 46 which supplies the control unit 6 with information about quantity, pressure, temperature and/or composition of the mixture which is carried in the line 45. Further sensors, which depend on the particular embodiment, are arranged in the lines 12 and/or 14 and supply the control unit with information about quantity, pressure, temperature and/or composition of the mixture carried in the line, are not shown for the sake of clarity in the drawing. The gas phase which has been separated off from the anode off-gas is introduced via the line 411 into the gas-cleaning facility 11, where undesirable emissions are removed, before the gas phase leaves the facility as off-gas which contains carbon dioxide CO₂.

The mixer 5 is connected via the lines 85 and 95 to the two fuel tanks, the methanol tank 8 and the water tank 9. The lines 85 and 95 each have a metering valve which is controlled by the control unit 6. Consequently, only a load-dependent quantity, which is set by the control unit 6, of methanol and/or water passes via the lines 85 and 95 into the mixer 5. From the mixer, the fuel mixture passes via the pump 7 into the evaporator 2 and, from there, into the anode-gas chambers of the fuel cell stack 1.

The cathode off-gas is introduced into the evaporator 2 via the line 12, so that, in a similar manner to the circuit for the anode outgoing air via the line 14, the waste heat from the used oxidizing agent is utilized to evaporate the unused fuel. According to one embodiment of the method, the evaporation temperature is lower than that of the stack off-gas. The evaporation temperature depends on the stoichiometry of the methanol/water mixture and is, for example, below 100° C. In the evaporator 2, product water is condensed out of the cathode off-gas, and this water is separated from the gaseous phase in the water separator 10. Undesirable emissions are removed from the gas phase obtained in this way by means of a gas-cleaning facility 11, before the gas phase is released to the environment as waste air exhaust via the line 110. The liquid phase from the water separator 10 is fed into the water tank 9 via the line 109, which has a sensor 106. The sensor 106 is connected to the control unit 6, which it supplies with information about the quantity, pressure, temperature and/or composition of the liquid phase from the water separator 10.

The evaporator 2 is fed not only via the line 72 but also via the line 122. Line 122 connects the evaporator 2 to the preheater 12, wherein, during the cold-start phase, methanol which flows into the preheater 12 via a metering valve controlled via the control unit 6, is preheated and/or filtered.

By way of example, the following information flows into the control unit 6:

The quantity, pressure, temperature and/or composition of the liquid phase recovered from the anode off-gas, via the sensor 46.

The quantity, pressure, temperature and/or composition of the liquid phase obtained from the cathode off-gas, via the sensor 106.

The quantity, pressure, temperature and/or composition of the water in the water tank and/or of the methanol in the methanol tank, via a sensor arranged in the tank or some other analysis unit installed in that position.

The load which is instantaneously demanded of the stack.

The cell voltage, the temperature distribution, the pressure, etc. of the stack(s).

The control unit then uses an existing algorithm or a manual input to determine setpoint values and controls the connected control devices, such as the pump 7, the compressor 3, the metering valves into the lines 85, 95 and 812, i.e. the line from the methanol tank 8 to the preheater 12, the evaporator 2, the stack 1, the preheater 12 and the gas-cleaning facilities 11.

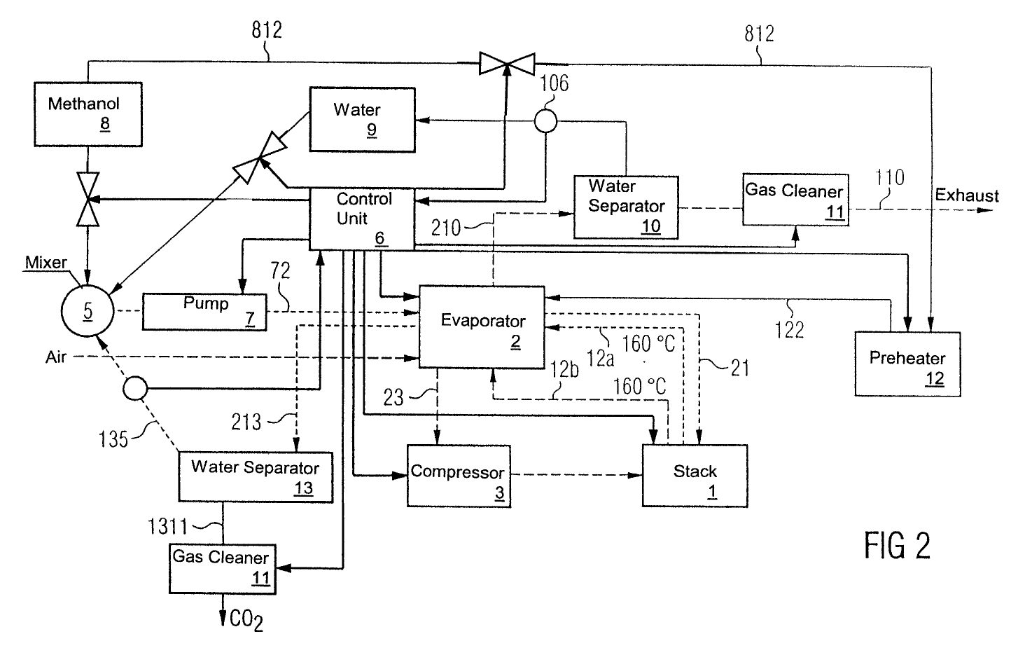

FIG. 2 shows a circuit diagram of a further DMFC installation. A significant difference from the facility shown in FIG. 1 is that both cathode off-gas and anode off-gas from the stack 1 are introduced into the evaporator 2 (lines 12a and 12b), wherein the oxidizing agent, preferably the air, is heated before it enters the compressor 3 and the fuel mixture is evaporated before it enters the stack 1. The anode off-gas, which has been cooled in the evaporator 2, is introduced via the line 213 into the water separator 13, where water and/or methanol which are still present are separated out before the liquid phase is introduced via the line 135 into the mixer 5 and the gaseous phase is introduced via the line 1311 into a gas-cleaning facility 11, wherein undesired emissions are removed.

For the sake of clarity, the fuel lines are indicated by lines made up of short dashes and the oxidizing-agent lines are indicated by lines made up of long dashes.

In both embodiments which are shown, the way wherein the cooling circuit is incorporated into the utilization of the stack waste heat has been omitted for the sake of clarity. The cooling circuit, if present, is preferably also passed through the evaporator or a unit for preheating the process media.

The term “fuel cell installation” denotes a system which comprises at least one stack with at least one fuel cell unit, the corresponding process-medium feed and discharge ducts, electrical lines and end plates, if appropriate a cooling system with cooling medium and all the fuel cell stack peripherals (reformer, compressor, preheater, blower, heater for process-medium preheating, etc.).

The term “stack” denotes a stack comprising at least one fuel cell unit with the associated lines and, if present, at least a part of the cooling system.

An antifreeze which is not electrically conductive may be contained in the cooling system. Other modules are kept at temperatures which are higher than the freezing point, which may differ according to the particular module (for example the freezing point for a water line differs from that for a water/methanol mixture line) either by the insulation methods (cf. above) and/or by local heater units.

The invention described herein provides for a DMFC installation which, at high operating temperatures (HTM fuel cell), optimizes the energy and fuel-related efficiency by utilizing the waste heat of the stack.

We claim:

1. A fuel cell installation, comprising:
at least one fuel cell stack;
process-medium supply lines connected to said fuel cell stack;
an evaporator connected upstream of said fuel cell stack in a flow direction; and
at least one line connected to said fuel cell stack for rendering a heat content from at least a part of said fuel cell stack available to be utilized in at least one further unit.

2. The fuel cell installation according to claim 1, wherein said evaporator is integrated in said fuel cell stack.

3. The fuel cell installation according to claim 1, wherein said evaporator and said fuel cell stack are accommodated in a common housing.

4. The fuel cell installation according to claim 1, wherein said fuel cell stack exhausts anode off-gas and cathode off-gas, and which comprises a heat exchanger receiving one of the anode off-gas and the cathode off-gas.

5. The fuel cell installation according to claim 1, which comprises a condenser forming a unit together with said evaporator.

6. The fuel cell installation according to claim 1, which further comprises a gas-cleaning facility for cleaning an off-gas from said fuel cell stack.

7. The fuel cell installation according to claim 1, wherein at least a part of a unit selected from the group consisting of a module, a tank, and a line is provided with one of an insulation and a local heating element.

8. The fuel cell installation according to claim 1, which comprises a device for selectively closing at least one of a feed opening of a process-medium and a coolant supply line.

9. The fuel cell installation according to claim 1, which comprises a filter connected upstream of the fuel cell stack.

10. The fuel cell installation according to claim 1, which comprises a control unit and at least one analysis unit connected in the installation, said control unit and analysis unit receiving information about measured actual values and, based on a comparison with setpoint values, controlling control devices of the installation to match the measured actual values to the setpoint values.

11. In a fuel cell installation of the type having an anode at which a methanol/water mixture is converted, the improvement which comprises a starter cartridge for starting the fuel cell installation, said starter cartridge containing a methanol/water mixture suitable for conversion at the anode in ready-to-use form.

12. In combination with a fuel cell installation, a hydrogen store connected in the fuel cell installation.

13. In a method of operating a fuel cell installation, which comprises utilizing waste heat from at least one part of a fuel cell stack in an operation of the fuel cell installation.

14. The method according to claim 13, which comprises utilizing the waste heat in a unit of the fuel cell installation that is to be heated.

15. The method according to claim 13, which comprises recovering and recirculating recyclable constituents of the fuel-cell stack off-gas.

16. The method according to claim 13, wherein the fuel cell installation contains at least one direct methanol fuel cell, and the method comprises recovering one of water and methanol from the off-gas of the direct methanol fuel cell, by introducing the off-gas into a heat exchanger selected from the group consisting of an evaporator, a unit for preheating process media, and a condenser.

17. The method according to claim 13, which comprises passing off-gas from the installation through a gas-cleaning facility.

18. The method according to claim 13, which comprises operating the fuel cell stack at an operating temperature of between 80° C. and 300° C.

19. The method according to claim 13, which comprises heating at least a part of a unit of the installation during an at-rest phase of the installation.

20. The method according to claim 13, which comprises insulating at least a part of unit of the installation for retaining a heat content during an at-rest phase of the installation.

21. The method according to claim 13, which comprises introducing hydrogen into the fuel cell stack as a fuel during a cold start of the fuel cell stack.

22. The method according to claim 21, which comprises, during the cold start, at least one of recycling and introducing into a gas-cleaning facility, hydrogen from a fuel-cell stack off-gas.

23. The method according to claim 13, which comprises guiding a cooling medium in co-current during the cold start of the installation.

24. The method according to claim 23, which comprises, after the cold start, switching the cooling medium to countercurrent to obtain an optimally uniform temperature profile.

25. The method according to claim 13, which comprises filtering at least one of the process medium and the cooling medium before being introduced into the fuel cell stack.

26. The method according to claim 13, which comprises providing a control unit for optimize an efficiency of the installation, the control unit receiving at least one measured actual value from at least one analysis unit, comparing the actual value with a predetermined or calculated setpoint value, and controlling at least one connected control device to match the actual value to the setpoint value.

27. The method according to claim 13, which comprises utilizing second waste heat.

28. The method according to claim 13, which comprises, during a cold start, feeding fuel to the fuel cell stack from a source selected from the group consisting of a liquid fuel source and a starter cartridge.

29. A method of operating a direct methanol fuel cell installation, which comprises providing an evaporator and operating the evaporator at an operating temperature below a temperature of a fuel-cell stack off-gas.

30. The method according to claim 29, which comprises introducing hydrogen into the fuel cell stack as a fuel during a cold start of the fuel cell stack.

31. The method according to claim 30, which comprises, during the cold start, at least one of recycling and introducing into a gas-cleaning facility, hydrogen from a fuel-cell stack off-gas.

32. The method according to claim 29, which comprises guiding a cooling medium in co-current during the cold start of the installation.

33. The method according to claim 32, which comprises, after the cold start, switching the cooling medium to countercurrent to obtain an optimally uniform temperature profile.

34. The method according to claim 29, which comprises filtering at least one of the process medium and the cooling medium before being introduced into the fuel cell stack.

35. The method according to claim 29, which comprises providing a control unit for optimize an efficiency of the installation, the control unit receiving at least one measured actual value from at least one analysis unit, comparing the actual value with a predetermined or calculated setpoint value, and controlling at least one connected control device to match the actual value to the setpoint value.

36. The method according to claim 29, which comprises refilling a hydrogen store by electrolysis of at least one of water and a water/methanol mixture.

37. The method according to claim 29, which comprises utilizing second waste heat.

38. The method according to claim 29, which comprises, during a cold start, feeding fuel to the fuel cell stack from a source selected from the group consisting of a liquid fuel source and a starter cartridge.

39. A fuel cell installation, comprising:
at least one fuel cell stack of DMFC fuel cells operated with a methanol/water mixture at an operating temperature between 100° C. and 300° C.;
process-medium supply lines of an operating circuit connected to said fuel cell stack;
an evaporator connected upstream of said fuel cell stack in a flow direction for evaporating the methanol/water mixture; and
a condenser connected to said fuel cell stack for condensing at least water out of an off gas selected from the group consisting of an anode off gas and a cathode off gas; and
a feedback for recycling condensate water into the operating circuit.

40. A method of operating a fuel cell installation having a fuel cell stack of DMFC fuel cells operated with evaporated methanol/water mixture and having an evaporator connected upstream thereof, the method which comprises:
operating the fuel cell stack in an operating temperature range between 100° C. and 300° C. with evaporated methanol/water mixture;
introducing fuel cell off gases at the operating temperature of the fuel cell stack into a condenser for recovering at least one of water and methanol; and
recovering useful components of the off gases.

41. The method according to claim 40, which comprises recycling the useful components of the off gases into the operating circuit.
